(19) United States
(12) Patent Application Publication
(10) Pub. No.: US 2011/0175731 A1
(43) Pub. Date: Jul. 21, 2011

(54) VENDING MACHINE WITH AN INTERACTIVE LIGHT DEVICE

(75) Inventor: Paolo Ghidotti, Urgnano (IT)

(73) Assignee: N&W GLOBAL VENDING S.P.A., Valbrembo (IT)

(21) Appl. No.: 12/992,599

(22) PCT Filed: May 12, 2009
(86) PCT No.: PCT/EP09/55738

§ 371 Date: Apr. 7, 2011

(30) Foreign Application Priority Data
May 13, 2008 (IT) TO2008A000356

(51) Int. Cl. G08B 21/00; G07F 11/00; G07D 1/02; B65G 59/00; G06F 17/00; G09F 9/33

(52) U.S. Cl. 340/540; 221/199; 453/18; 221/1; 700/232; 340/815.45

(57) ABSTRACT

A product vending machine having a casing housing products for dispensing; a pay unit having a pay interface; a product dispenser unit having a product pickup compartment formed in the casing; and an interactive light device having a first and a second light emitter located on the casing, adjacent to the pay interface and the product pickup compartment respectively, and an electronic control unit for selectively controlling the first and second light emitter in at least three different light signaling modes, each indicating a specific operation to be performed by the user regarding the pay interface and/or product pickup compartment.

### TECHNICAL FIELD

The present invention relates to a product vending machine with an interactive light device for focusing the user's attention on the operations to be performed by the user to select/obtain the products.

More specifically, the present invention relates to a vending machine of the type comprising: a casing housing the products for sale, such as beverages, snacks, or similar; a pay unit with a pay interface on the visible wall of the casing; and a product dispensing unit with a product pickup compartment in the same wall.

### BACKGROUND ART

Operating vending machines of the above type calls for various commands/operations on the part of the user to obtain the desired product. Though straightforward and few in number, the operations to be performed may pose problems for certain types of users, such as elderly people or children, for whom the operating procedure may not always be clear.

Moreover, users of vending machines of the above type are often so distracted by the operating procedure that they neglect to collect their change from the outer change pocket of the machine.

### DISCLOSURE OF INVENTION

It is an object of the present invention to provide a vending machine designed to visually focus the attention of the user on the operations to be performed to select/obtain the products.

According to the present invention, there is provided a vending machine as claimed in claim 1 and preferably, though not necessarily, in any one of the dependent Claims.

According to the present invention, there is also provided a method of operating a product vending machine, as claimed in claim 8 and preferably, though not necessarily, in any one of the dependent Claims.

According to the present invention, there is also provided a software product as claimed in claim 14.

### BRIEF DESCRIPTION OF THE DRAWINGS

A non-limiting embodiment of the present invention will be described by way of example with reference to the accompanying drawings, in which:

FIG. 1 shows a schematic front view, with enlargements for clarity, of a product vending machine in accordance with the teachings of the present invention;

FIG. 2 shows an operating flow chart of the method of operating the FIG. 1 vending machine.

### BEST MODE FOR CARRYING OUT THE INVENTION

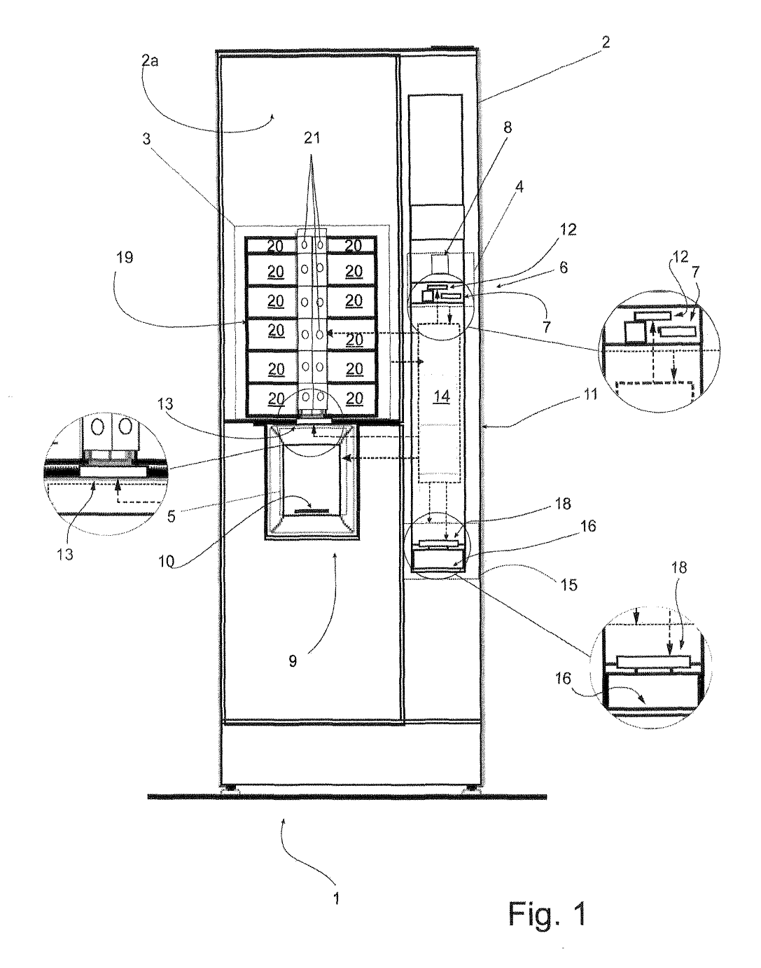

Number 1 in FIG. 1 indicates as a whole a food product vending machine designed to generate light signals to focus the user's attention on the operations to be performed by the user to obtain a given product from vending machine 1.

Vending machine 1 substantially comprises a casing 2 housing the products for dispensing, such as hot or cold beverages, soft drinks, snacks or similar food products; an electronic user selection unit 3 by which to select a given product; a user pay unit 4 by which to pay a given sum for the selected product; and a dispenser unit 5 for dispensing the selected product to the user.

Pay unit 4 comprises a pay interface 6 located on a visible wall 2a of casing 2 and having a slot 7 for inserting coins and/or a memory key and/or card reader 8.

Dispenser unit 5 comprises a delivery interface 9 in turn comprising a pickup compartment 10 formed in wall 2a of casing 2 and from which the user collects the selected product from vending machine 1.

Vending machine 1 also comprises an interactive light device 11 designed to generate a predetermined sequence of light signals at various given areas/points of vending machine 1, to visually focus the user's attention on the operations to be performed by the user on vending machine 1 to select/obtain the products.

More specifically, interactive light device 11 substantially comprises a first and second light emitter 12, 13 located on wall 2a of casing 2, adjacent to pay interface 6 and pickup compartment 10 respectively; and an electronic control unit 14, which selectively controls first and second light emitter 12, 13 in at least three different light signaling modes, each indicating a specific operation to be performed by the user regarding pay interface 6 and/or pickup compartment 10.

In the FIG. 1 example, compartment 10 comprises a preferably, though not necessarily, rectangular opening, and second light emitter 13 is conveniently located on the outer face of wall 2a, just above and adjacent to the top edge of the opening.

In the FIG. 1 example, first light emitter 12 is conveniently located on the outer face of wall 2a, between slot 7 and reader 8.

Vending machine 1 also comprises an electromechanical change unit 15 in turn comprising an outer user change collect pocket 16 formed in wall 2a of casing 2.

Interactive light device 11 also comprises a third light emitter 18 located on wall 2a of casing 2, adjacent to outer change collect pocket 16.

In the FIG. 1 example, pocket 16 comprises a preferably, though not necessarily, rectangular opening, and third light emitter 18 is conveniently located on the outer face of wall 2a of casing 2, just above the top edge of the opening.

Electronic control unit 14 selectively controls third light emitter 18 in three light signaling modes, each associated with a specific user operation on change collect pocket 16.

Electronic selection unit 3 comprises a product selection user interface 19 located on wall 2a of casing 2 and in turn comprising a number of buttons 20, each relating to a preselection operation or selection operation to select a product from vending machine 1; and a number of auxiliary indicator light sources 21 located on wall 2a, adjacent to selection buttons 20.

In the FIG. 1 example, auxiliary light sources 21 and first, second, third light emitters 12, 13, 18 each comprise at least one LED (Light Emitting Diode); a rectangular panel of transparent/semitransparent material fixed to the outer face of wall 2a to diffuse the light emitted by the LED; and an electric control circuit (not shown) designed to selectively control the LED in three different light signaling modes.

It should be pointed out that, in one possible embodiment, auxiliary light sources 21 and/or first light emitter 12 and/or second light emitter 13 and/or third light emitter 18 may each comprise an incandescent or fluorescent lamp and/or any other type of lamp or similar electric/electronic device capable of emitting a light signal.

More specifically, the three light signaling modes comprise: a first LED “OFF” mode corresponding to a “rest condition”, i.e. no specific operation to be performed by the user; a second LED “ON” mode corresponding to an “operating condition” indicating a specific operation being performed by vending machine 1; and a third “flashing” LED mode corresponding to an “alert condition” indicating a specific operation to be performed by the user.

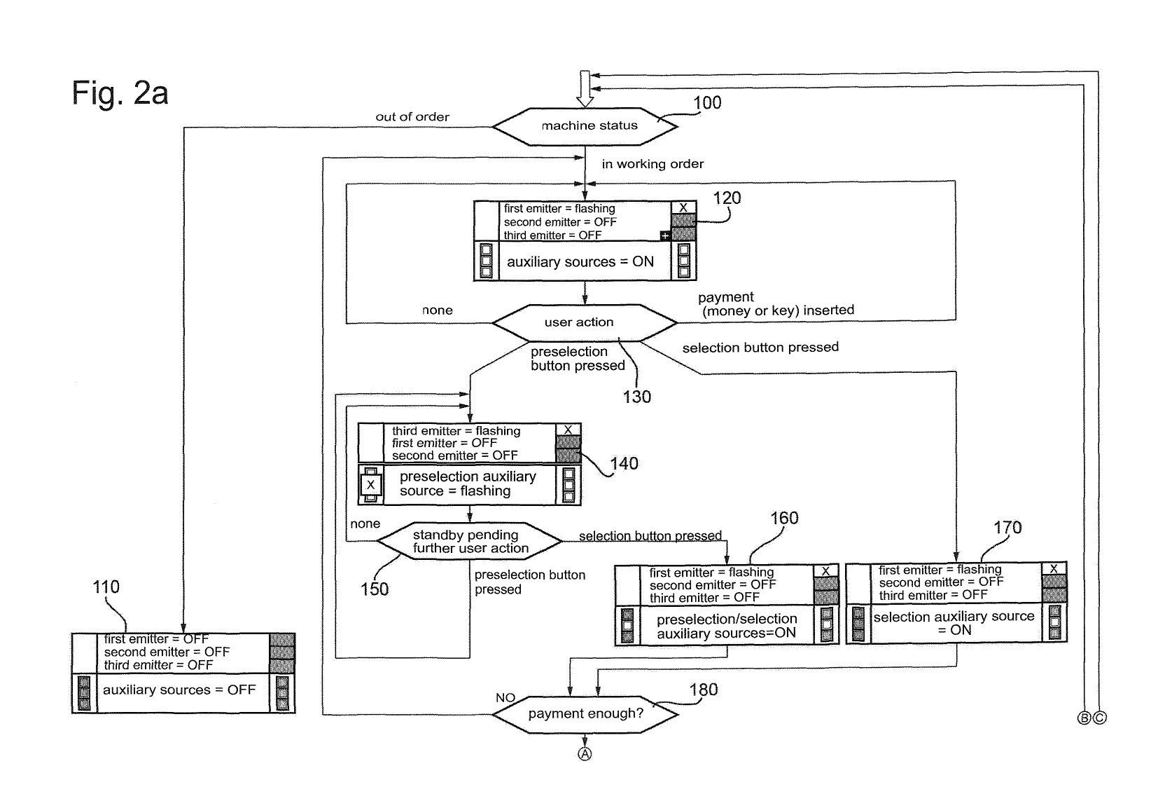

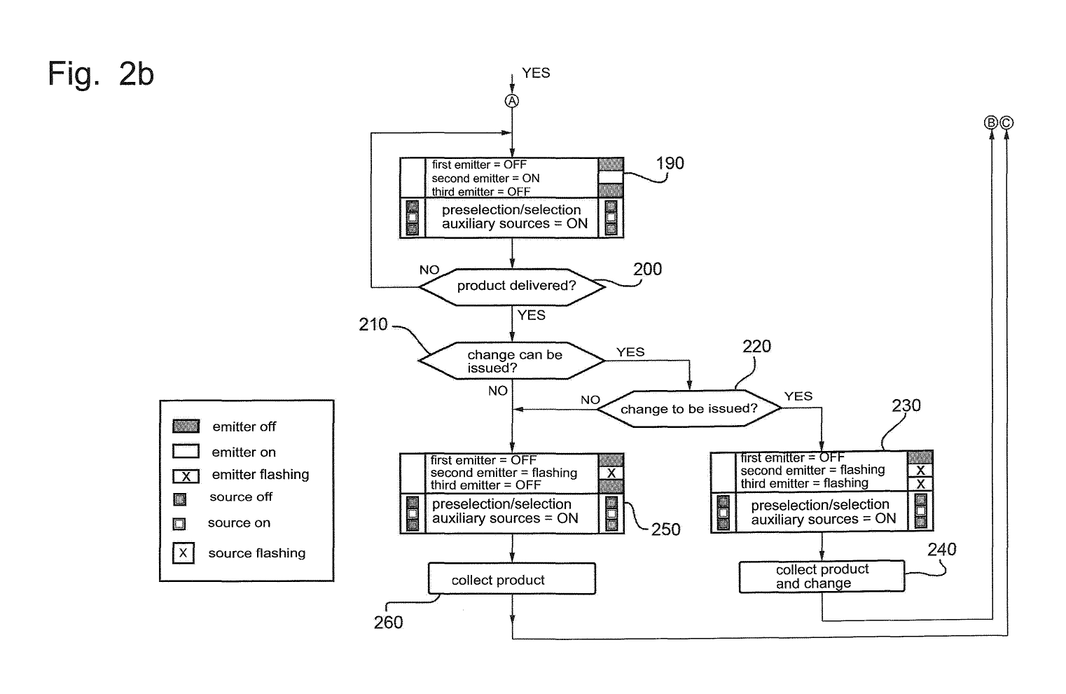

One possible implementation of the operating method of interactive light device 11 of vending machine 1 will now be described with reference to FIG. 2. It should be pointed out that the operations in the present operating method described below may be contained in a software program contained in a memory module (not shown) of electronic control unit 14. In other words, the software program may be implemented by electronic control unit 14 to implement the present operating method of interactive light device 11 of vending machine 1.

To begin with, electronic control unit 14 determines the operating status of vending machine 1 (block 100), and, in the event the machine is out of order or unable to dispense products, sets first, second and third emitters 12, 13, 18 and auxiliary sources 21 to OFF (block 110).

Conversely, on determining vending machine 1 to be in working order, electronic control unit 14 switches to a standby condition, in which second and third light emitters 13, 18 are set to OFF, and, at the same time, first light emitter 12 is set to flashing mode to draw the user's attention to pay interface 6 (block 120).

In the example shown, at this stage, the flashing light signal generated by first emitter 12 on pay interface 6 conveniently informs the user that the specific operation to be performed is a pay operation. It should be pointed out that, at this stage, electronic control unit 14 preferably, though not necessarily, sets all the auxiliary sources 21 of user interface 19 to ON.

At this point, electronic control unit 14 determines product selection operation of user interface 19 (block 130).

In the event of no operation on the part of the user, electronic control unit 14 leaves first, second, and third light emitters 12, 13, 18 in the same modes as in block 120; whereas, if a preselection button is found to have been pressed by the user (block 140), electronic control unit 14 sets the light source 21 of the pressed preselection button 20 to flashing mode, and at the same time leaves all the other light sources 21 in the same modes as before.

At this point, electronic control unit 14 switches to standby pending operation of a selection button (block 150). If another preselection button is pressed, the method performs the block 140 operation again; whereas, if a selection button is pressed, electronic control unit 14 turns on the preselection button light source 21, leaves the pressed selection button light source 21 on, and turns off all the other light sources (block 160).

If user operation of a selection button 20 is determined in block 130, electronic control unit 14 leaves the light source 21 of the pressed selection button 20 on, and at the same time turns the other light sources 21 off (block 170).

At this point, on the basis of the price of the selected product, electronic control unit 14 determines whether or not payment by the user on pay interface 6 exceeds the price of the selected product (block 180).

If payment by the user is less than the price of the selected product (NO output of block 180), electronic control unit 14 leaves first light emitter 12 in flashing mode to keep the user focused on the pay operation; whereas, if payment by the user exceeds or equals the price of the selected product (YES output of block 180), electronic control unit 14 turns off first light emitter 12, and turns on second light emitter 13 to inform the user that the selected product is being dispensed by vending machine 1 (block 190). At this stage, electronic control unit 14 leaves third light emitter 18 off to indicate no change-making activity by electromechanical unit 15.

At this point, electronic control unit 14 determines whether or not the product has been fed into pickup compartment 10 (block 200).

If it has not (NO output of block 200), i.e. the product is still being dispensed, electronic control unit 14 leaves light emitters 12, 13, 18 in the same modes as before.

If it has (YES output of block 200), i.e. the product has been delivered, electronic control unit 14 determines whether or not electromechanical unit 15 is able to make change (block 210).

It should be pointed out that, at this stage (block 200), electronic control unit 14 determines delivery of the product, both in the event the product is delivered as designed by vending machine 1, and in the event of only partial delivery of the product, due to malfunctioning and/or product shortage and/or similar factors.

At this point, if electromechanical unit 15 is able to make change (block 210) and payment by the user exceeds the price of the selected product (block 220), electronic control unit 14 commands change be fed to pocket 16, and sets second and third light emitters 13, 18 to flashing mode (block 230) to instruct the user to collect the product from compartment 10 and the change from pocket 16 respectively. At this stage, electronic control unit 14 leaves first light emitter 12 off.

At this point, electronic control unit 14 continues to flash second and third light emitters 13, 18 until the product is collected from compartment 10 and the change from pocket 16 respectively (block 240). Once the product is collected from compartment 10, electronic control unit 14 turns off second light emitter 13 (block 100).

Once the change is collected from pocket 16, electronic control unit 14 turns off third light emitter (block 100). It should be pointed out that collection of the product from compartment 10 and/or of the change from pocket 16 may be determined by electronic control unit 14 by means of sensors (not shown) inside compartment 10 and/or pocket 16.

In a different embodiment, electronic control unit 14 may turn off second and third light emitters 13, 18 after a predetermined time interval from when the product and change are delivered to compartment 10 and pocket 16.

Conversely, if electromechanical unit 15 is found to be unable to make change in block 210 (NO output of block 210) and/or payment by the user equals the price of the selected product (NO output of block 220), electronic control unit 14 sets second light emitter 13 to flashing mode to instruct the user to collect the product from compartment 10, and at the same time turns off third light emitter 18 to indicate no user action regarding pocket 16.

Once the product is collected from compartment 10 (block 260), electronic control unit 14 turns off second light emitter 13, and repeats the above operations starting from block 100, i.e. determines the operating status of vending machine 1.

The vending machine described has the major advantage of focusing the user's attention on the operations to be performed by the user to select/obtain the products.

Clearly, changes may be made to the vending machine as described and illustrated herein without, however, departing from the scope of the present invention as defined in the accompanying Claims.

1. A product vending machine comprising;
a casing housing products for dispensing;
a pay unit having a pay interface on a wall of said casing;
a product dispenser unit in turn comprising a product pickup compartment formed in said wall;
a product selection user interface located on said wall of the casing and in turn comprising a number of product selection and/or preselection buttons;
an interactive light device for visually focusing the attention of a user on the operations to be performed to select/obtain said products, the interactive light device comprising:
a first and a second light emitter, which are located on said wall of the casing, adjacent to said pay interface and said product pickup compartment respectively;
auxiliary light signaling means adjacent to said selection and/or preselection buttons;
electronic control means configured to selectively control said first, said second light emitter, and said auxiliary light signaling means in three different light signaling modes, each indicating a specific operation to be performed by the user regarding said pay interface, and/or said product pickup compartment, and/or said selection and/or preselection buttons;
said electronic control means being further configured to selectively command the three light signaling modes of said first, and/or said second, and/or said auxiliary light signaling means in a predetermined sequence associated with an orderly succession of operations to be performed by the user to select/obtain the products.

2. A vending machine as claimed in claim 1, further comprising;
a change dispenser unit in turn comprising an outer change collect pocket for issuing change to the user and formed in said wall of the casing, and a third light emitter located on said wall, adjacent to said outer change collect pocket; said electronic control means selectively controlling said third light emitter in said three light signaling modes, each indicating a specific operation to be performed by the user regarding said outer change collect pocket.

3. A vending machine as claimed in claim 2, wherein said electronic control means are configured to selectively command three different light signaling modes of said first, and/or said second, and/or said third light emitter, and/or said auxiliary light signaling means in a predetermined sequence associated with an orderly succession of operations to be performed by the user to select/obtain the products.

4. A vending machine as claimed in claim 2, wherein said first and/or second and/or third light emitter and/or said auxiliary light signaling means each comprise at least one LED.

5. A vending machine as claimed in claim 1, wherein said three light signaling modes comprise a first mode corresponding to no specific action to be performed by the user; a second mode corresponding to a specific action being performed by said vending machine; and a third mode corresponding to an alert condition.

6. A vending machine as claimed in claim 5, wherein said third light signaling mode is a flashing mode of a light signal.

7. A method of operating a product vending machine comprising a casing housing products for dispensing; a pay unit having a pay interface on a wall of said casing; a product dispenser unit having a product pickup compartment formed in said wall; and a product selection user interface located on said wall of the casing and in turn comprising a number of product selection and/or preselection buttons; and
a interactive light device comprising:
at least a first and a second light emitter, which are located on said wall of the casing, adjacent to said pay interface and said product pickup compartment respectively; and
auxiliary light signaling means adjacent to said selection and/or preselection buttons;
said method comprising the steps of:
selectively controlling said first, and/or said second light emitter, and/or said auxiliary light signaling means in three different light signaling modes each indicating a specific operation to be performed by the user regarding said pay interface, and/or said product pickup compartment, and/or said selection and/or preselection buttons; the light signaling modes of said first, second and said auxiliary light signaling means being commanded in a predetermined sequence associated with an orderly succession of operations to be performed by the user to select/obtain the products.

8. A method as claimed in claim 7, wherein said vending machine comprises a change dispenser unit in turn comprising an outer change collect pocket formed in said wall of the casing, and a third light emitter located on said wall, adjacent to said outer change collect pocket; said method further comprising the step of selectively controlling said third light emitter in said three light signaling modes, each indicating a specific operation to be performed by the user regarding said outer change collect pocket.

9. A method as claimed in claim 8, further comprising the step of selectively commanding the light signaling modes of said first, and/or said second, and/or said third light emitter, and/or said auxiliary light signaling means in a predetermined sequence associated with an orderly succession of operations to be performed by the user to select/obtain the products.

10. A method as claimed in claim 7, wherein said three light signaling modes comprise a first mode corresponding to no specific action to be performed by the user; a second mode corresponding to a specific action being performed by said vending machine; and a third mode corresponding to an alert condition.

11. A method as claimed in claim 10, wherein said third light signaling mode corresponds to a flashing mode of a light signal.

12. A software product loadable into the memory of electronic control means of a product vending machine, and designed to implement, when executed, the method as claimed in claim 7.
